(19) United States
(12) Patent Application Publication
(10) Pub. No.: US 2025/0013083 A1
(43) Pub. Date: Jan. 9, 2025

(54) III-V/SI HYBRID MOS OPTICAL MODULATOR WITH A TRAVELING-WAVE ELECTRODE

(71) Applicant: ADVANCED MICRO FOUNDRY PTE. LTD., Singapore (SG)

(72) Inventors: Qiang LI, Singapore (SG); Xianshu LUO, Singapore (SG)

(73) Assignee: ADVANCED MICRO FOUNDRY PTE. LTD., Singapore (SG)

(21) Appl. No.: 18/706,059

(22) PCT Filed: Nov. 11, 2021
(86) PCT No.: PCT/SG2021/050692

§ 371 Date: Apr. 30, 2024

(51) Int. Cl. G02F 1/015

(52) U.S. Cl. CPC G02F 1/015; G02F 2201/126; G02F 2201/127; G02F 2202/105; G02F 2203/50

(57) ABSTRACT

A III-V/Si hybrid MOS optical modulator with a traveling-wave electrode for high-efficiency and high-bandwidth optical modulation is disclosed. The III-V/Si hybrid MOS optical modulator equipped with a traveling-wave electrode becomes a traveling-wave modulator. The traveling-wave modulator comprises a III-V compound semiconductor layer, a silicon layer and an oxide layer between the III-V compound semiconductor layer and the silicon layer. The traveling-wave modulator comprises of at least one first metallic layer, at least one second metallic layer and a semiconductor layer. The electrode trace width of each second metallic layer and the spacing between adjacent second metallic layers are adjusted to achieve the impedance and velocity matching. A traveling-wave electrode is designed to integrate with the III-V/Si hybrid MOS optical modulator under forward and reverse bias.

### TECHNICAL FIELD

The present disclosure relates generally to a III-V compound semiconductor and silicon (Si) hybrid Metal-Oxide-Semiconductor (MOS) optical modulator with a traveling-wave electrode. The traveling-wave modulator uses Series-Push-Pull (SPP) driving scheme to mitigate the influence of large capacitance for high-speed modulation.

### BACKGROUND

A III-V compound semiconductor is an alloy, containing elements from groups III and V in the periodic table. Within the III-V semiconductors there are the nitride semiconductors subset. III-V/Si hybrid Metal-Oxide-Semiconductor (MOS) optical modulator is promising for high-efficiency, low-energy and high-speed optical modulation. However, there is no demonstration of III-V/Si hybrid MOS optical modulator with travelling-wave electrode, as MOS optical modulators have large oxide capacitance which makes the impedance and velocity matching challenging.

There is a trade-off relationship between modulation efficiency and modulation bandwidth. As of now, the available MOS-type optical modulators are equipped with lumped electrodes. The modulation bandwidth is limited by the large oxide capacitance, especially under forward bias. With modulation bandwidth reaching 30 GHz, the parasitic effects from metal pad and substrate are becoming more significant, further limiting the achievable modulation bandwidth. The large oxide capacitance also poses challenge to the design of traveling-wave electrode since it is difficult to realize velocity and impedance matching with an over-large load capacitance.

In the current technology field and published literature, there is disclosed the following modulators:
high-speed silicon optical modulator based on a metal-oxide-semiconductor capacitor. In this prior art, the modulator has a Poly-Si/Si MOS structure, the electrodes are of lumped in nature, the bandwidth is of approximately 1 GHz and phase shifter length is of 2.5 mm;
a high-speed and high-efficiency Si optical modulator with MOS junction, using solid-phase crystallization of polycrystalline silicon and a high-performance MOS-capacitor-type Si optical modulator and surface-illumination-type Ge photodetector for optical interconnection. The modulator has a Poly-Si/Si MOS structure, the electrodes are of lumped in nature, the bandwidth is of approximately 4 to 7 GHz and phase shifter length is of 200 μm;
high bandwidth capacitance efficient silicon MOS modulators, where the modulator has a Poly-Si/Si MOS structure, the electrodes are of lumped in nature, the bandwidth is of greater than 35 GHz and phase shifter length is of 200 μm;
a SiGe-enhanced Si capacitive modulator integration in a 300 mm silicon photonics platform for low power consumption. The modulator has a Poly-Si/SiGe MOS structure, the electrodes are of lumped in nature, the bandwidth is approximately of 4 GHz and phase shifter length is of 700 μm;
a 30 GHz heterogeneously integrated capacitive InP-on-Si Mach-Zehnder modulators. In this prior art, the modulator has a InP/Si MOS structure, the electrodes are of lumped in nature, the bandwidth is approximately of 11 (30) GHz and phase shifter length is of 500 (200) μm;
a heterogeneously integrated III-V/Si MOS capacitor Mach-Zehnder modulator. In this prior art, the modulator has a InGaAsP MOS structure, the electrodes are of lumped in nature, the bandwidth is approximately of 2.2 GHZ and phase shifter length is of 250 μm.

In view of the foregoing, conventional MOS optical modulators with large oxide capacitance limits the modulation bandwidth. When modulation frequency exceeds 30 GHz, the parasitic effects from metal pads and substrate become significant, which further limits the achievable modulation bandwidth.

A need therefore exists for a III-V/Si hybrid MOS optical modulator with a traveling-wave electrode that can achieve a large modulation bandwidth with a high modulation efficiency simultaneously.

### SUMMARY

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, and abstract as a whole.

In a first aspect of the present disclosure a III-V/Si hybrid MOS optical modulator with a traveling-wave electrode comprising: a first and second metal layer serving as the traveling-wave electrode; a III-V compound semiconductor layer, a silicon layer and an oxide layer between the III-V compound semiconductor layer and the silicon layer; wherein the oxide layer thickness is designed to allow for the impedance and velocity matching of the modulator.

According to the first aspect of the present disclosure, further comprising at least one first connector and at least one second connector.

According to the first aspect of the present disclosure, the traveling-wave electrode is driven by a Series-Push-Pull (SPP) driving scheme.

According to the first aspect of the present disclosure, the first metallic layer comprises three metallic sections separate from each other.

According to the first aspect of the present disclosure, the second metallic layer comprises two metallic sections separate from each other.

According to the first aspect of the present disclosure, each second metallic section has a spacing distance between adjacent second metallic sections of about 5 μm to 60 μm.

According to the first aspect of the present disclosure, the thickness of the oxide layer is from about 5 nm to 50 nm.

According to the first aspect of the present disclosure, the III-V compound semiconductor layer comprises InGaAsP, InP or other III-V compound material with strong optical-electrical effect.

In a second aspect of the present disclosure a method of obtaining a design parameter for manufacturing a III-V/Si hybrid MOS optical modulator with a traveling-wave electrode, comprising steps of: fabricating a III-V compound semiconductor layer and a silicon layer, wherein an oxide layer is between the III-V compound semiconductor layer and the silicon layer; fabricating a first connector with connection to the semiconductor layer; fabricating a first metallic layer with connection to the first connector; fabricating a second connector with connection to the first metallic layer; and fabricating a second metallic layer with connection to the second connector, wherein the oxide layer thickness is designed to allow for the impedance and velocity matching of the modulator. The oxide layer thickness affects the resultant modulation efficiency and bandwidth, that is, over-thin or over-thick oxide layer makes the impedance and velocity matching unachievable.

According to the second aspect of the present disclosure, the traveling-wave electrode is driven by a Series-Push-Pull (SPP) driving scheme.

According to the second aspect of the present disclosure, the first metallic layer comprises three first metallic sections separate from each other.

According to the second aspect of the present disclosure, the second metallic layer comprises two second metallic sections separate from each other.

According to the second aspect of the present disclosure, each second metallic section has a spacing distance between adjacent second metallic sections of about 5 μm to 60 μm.

According to the second aspect of the present disclosure, the thickness of the oxide layer is from about 5 nm to 50 nm.

### BRIEF DESCRIPTION OF THE DRAWINGS

FIG. 1 illustrates a schematic diagram of a III-V/Si hybrid MOS optical modulator with a traveling-wave electrode and SPP driving scheme.

FIG. 2 illustrates a block diagram showing various elements and processes involved in the simulation for obtaining the design parameters of a traveling-wave electrode for a III-V/Si hybrid MOS optical modulator.

FIG. 3 illustrates a schematic diagram of the III-V/Si hybrid MOS optical modulator operated under forward bias.

FIG. 4 illustrates a schematic diagram of the III-V/Si hybrid MOS optical modulator operated under reverse bias.

FIG. 5A illustrates a characteristic impedance graph drawn taking electrode spacing along X-axis and electrode trace width along Y-axis during carrier accommodation in forward bias.

FIG. 5B illustrates a microwave refractive index graph drawn taking electrode spacing along X-axis and electrode trace width along Y-axis during carrier accommodation in forward bias.

FIG. 6A illustrates a characteristic impedance graph drawn taking electrode spacing along X-axis and electrode trace width along Y-axis during carrier depletion in reverse bias.

FIG. 6B illustrates a microwave refractive index graph drawn taking electrode spacing along X-axis and electrode trace width along Y-axis during carrier depletion in reverse bias.

FIG. 7A illustrates a simulated modulation bandwidth graph drawn taking frequency along X-axis and S-21 response along Y-axis during carrier accommodation in forward bias.

FIG. 7B illustrates another simulated modulation bandwidth graph drawn taking frequency along X-axis and S-21 response along Y-axis during carrier accommodation in forward bias.

FIG. 7C illustrates a simulated modulation bandwidth graph drawn taking sound level along X-axis and frequency along Y-axis during carrier depletion in reverse bias.

FIG. 7D illustrates another simulated modulation bandwidth graph drawn taking frequency along X-axis and S-21 response along Y-axis during depletion in reverse bias.

FIG. 8 illustrates a flow chart of an example process of obtaining a design parameter for manufacturing of a traveling-wave electrode used in a III-V/Si hybrid MOS optical modulator.

FIG. 9 illustrates a flow chart of an example process of achieving an electrode width and spacing design to realize the impedance and velocity matching for traveling-wave modulator.

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

### DETAILED DESCRIPTION OF ILLUSTRATIVE EMBODIMENTS

The particular configurations discussed in the following description are non-limiting examples that can be varied and are cited merely to illustrate at least one embodiment and are not intended to limit the scope thereof.

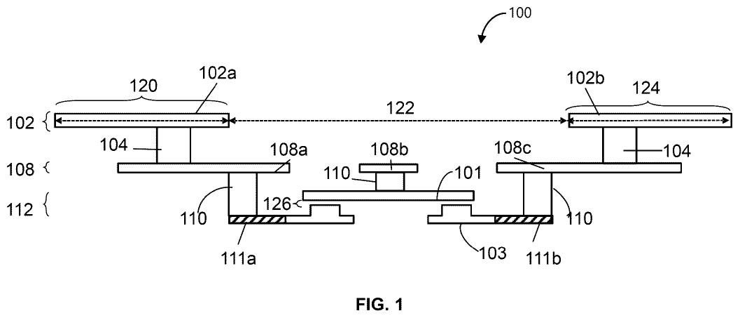

FIG. 1 illustrates a schematic diagram of a III-V/Si hybrid MOS optical modulator with a traveling-wave electrode driven by a series-push-pull (SPP) scheme. The cross-sectional schematic 100 indicates exemplified design parameter of various layers and orientation of components with respect to one another in providing a traveling-wave electrode used in a III-V/Si hybrid MOS optical modulator with the desired properties and characteristics. The provided modulator disclosed herein can also be termed as a traveling-wave modulator.

In one embodiment, the modulator disclosed herein can comprise at least one semiconductor layer 112, at least one first metallic layer 108 and at least one second metallic layer 102 arranged in a predetermined manner as shown in FIG. 1. At least one first connector 110 can connect the first metallic layer 108 and the semiconductor layer 112. At least one second connector 104 can connects the first metallic layer 108 and the second metallic layer 102.

The semiconductor layer 112 can comprise a silicon layer 103, an oxide layer 126 and a III-V compound semiconductor layer 101, forming an oxide capacitor. The first metallic layer 108, the second metallic layer 102 and the semiconductor layer 112 can be arranged and configured such that the impedance and velocity matching of the traveling-wave modulator can be achieved simultaneously.

In one embodiment, the oxide layer 126 separates the III-V semiconductor layer 101 and silicon layer 103, whereby the modulator disclosed herein can be filled with silicon oxide to fill the space or gap between the III-V semiconductor layer 101 and silicon layer 103 to provide the oxide layer 126.

In one embodiment, the first metallic layer 108 can comprise three first metallic sections separate from each other 108a, 108b, 108c. Two distal metallic sections 108a, 108c can be positioned at opposite ends of the semiconductor layer 112 with an overlapping portion to allow connection thereto. The remaining metallic section 108b can be positioned proximally and centrally relative to the semiconductor layer 112. In this embodiment, three connectors 110 can be used for connecting the three metallic sections in the first metallic layer 108 to the semiconductor layer 112.

In one embodiment, the second metallic layer 102 can comprise two second metallic sections separate from each other 102a, 102b. Each of the two metallic sections 102a, 102b can be positioned to overlap with one of the distal metallic sections 108a, 108c to allow connection thereto. In this embodiment, two connectors 104 can be used for connecting the two metallic sections in the second metallic layer 102 to two distal metallic sections in the first metallic layer 108.

In one embodiment, the second metallic section 102a, 102b can have a trace width 120, 124 and a spacing distance 122 between adjacent second metallic sections.

To achieve the impedance and velocity matching for MOS traveling-wave optical modulator, the widths 120, 124, spacing 122 and the thickness of the oxide layer (i.e. gap) 126 between III-V semiconductor layer 101 and silicon layer 103 are important factors for consideration. Measurements 120, 122, and 124 can each be varied from 20 μm to 130 μm depending on the oxide capacitance which is determined by the thickness of the oxide layer 126. In one embodiment, the spacing 122 can be in the range of 5 μm to 60 μm. In one embodiment, the spacing 122 can be selected from about 20 μm, 30 μm, 40 μm or 50 μm. For carrier-accumulation mode with an oxide layer thickness of 45 nm, when the spacing 122 increases from 20 μm to 50 μm, the width 120 and 124 changes from 46.7 μm to 126.7 μm linearly. For carrier-depletion mode with an oxide layer thickness of 10 nm, when the spacing 122 increases from 20 μm to 50 μm, the width 120 and 124 changes from 27.1 μm to 119.5 μm linearly.

The thickness of the oxide layer can be thick enough to allow for the impedance and velocity matching. The thickness of the oxide layer 126 (i.e. gap between 101 and 103) can be varied from 5 nm to 100 nm, preferably from 5 nm to 50 nm. In one embodiment for carrier-deletion mode with a reverse bias, the thickness of the oxide layer is about 10 nm. In one embodiment for carrier-accumulation mode with a forward bias, the thickness of the oxide layer is about 45 nm.

Using a series-push-pull (SPP) driving scheme 100, the trace width 120 and/or 124 of each second metallic section (102a and 102b) and the spacing 122 between adjacent second metallic sections can be adjusted by altering the position of the first connector 110 and second connector 104. The central first metal section 108b can be used to provide electrical bias for III-V/Si hybrid MOS optical phase shifters on the left and right side of the 108b. With a microwave modulating signal applied on the second metallic sections 102a and 102b, the modulating signal can be evenly distributed on two III-V/Si hybrid MOS optical phase shifters. Since two III-V/Si hybrid MOS optical phase shifters are connected in series, the total equivalent capacitance is halved. The predetermined structure leads to the impedance and velocity matching of the traveling-wave modulator. In one embodiment of the invention, the large oxide capacitance is halved by using SPP driving which makes the impedance and velocity matching possible for the traveling-wave modulator. The impedance and velocity matching will lead to an over-60 GHz modulation bandwidth with a small bias voltage. Thus, the spacing and trace width of the traveling wave electrode are important design parameters.

The III-V/Si hybrid MOS optical modulator disclosed herein can be designed to consider, the distance between the connector and metallic layer, the width of doping regions 111a and 111b, the spacing 122 of adjacent second metal sections in the same second metal layer. In this regard, the doping region is inside the silicon region of 103, whereby the width of the doping regions 111a and 111b can be 3-6 μm. The distance between the connector and the metallic layer, and the spacing of adjacent metal sections are limited by the lithography used in fabrication and can range in 1-90 μm. The spacing and trace width in the second metal layer, as well as the thickness of the oxide layer can be designed to achieve impedance and velocity matching. The SPP driving scheme reduced the capacitance by half, making the impedance and velocity matching possible.

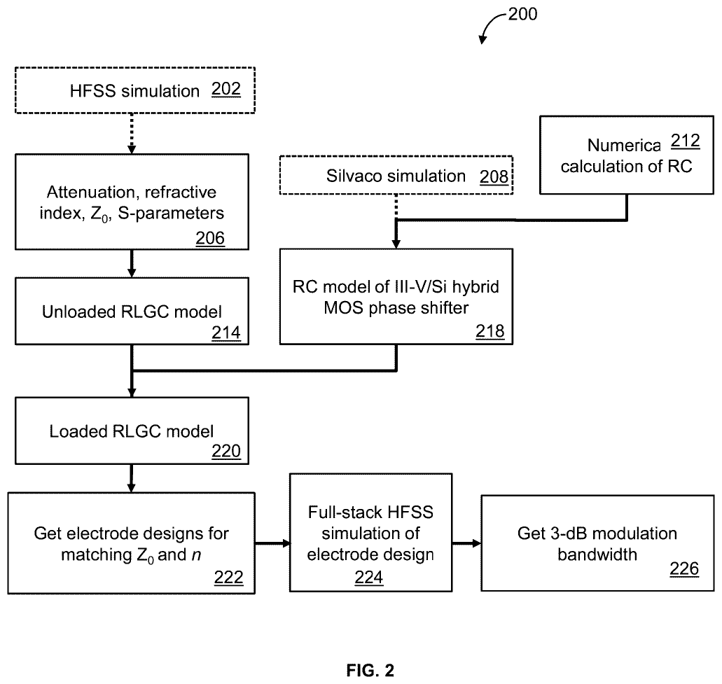

FIG. 2 illustrates a block diagram 200 showing various elements and processes involved in a simulation for obtaining the design parameters of a traveling-wave electrode for a III-V/Si hybrid MOS optical modulator. The HFSS simulation process starts at step 202 to simulate various electrode designs with different spacing and width by using HFSS. As at step 206, the attenuation, refractive index, Z₀ and S-parameters are obtained. Then, the data from step 206 is used to build a RLGC model in step 214. As at steps 208, a Silvaco simulation is run to obtain the RC model of III-V/Si hybrid MOS optical phase shifter as at steps 218. This step could also be carried out by numerical calculation as at steps 212. The unloaded RLGC model is loaded with the RC model of III-V/Si hybrid MOS phase shifter. As at steps 220 and 222, the loaded RLGC model produces the electrode designs for matching Z₀ and n. As at steps 224 and 226, the full-stack HFSS simulation of a III-V/Si hybrid MOS optical modulator is performed and the corresponding 3-dB modulation bandwidth are obtained. By changing the electrode width and spacing, this simulation flow gives different characteristic impedance Z₀ and refractive index n. The impedance and velocity matching condition is achieved when Z₀ is close to 50 (and n is close to 3.7 which is the optical group refractive index. The 3-dB modulation bandwidth is expected to be high under the impedance and velocity matching condition. Using this simulation flow, the relationship between the electrode width and spacing that enables impedance and velocity matching of the modulator is obtained.

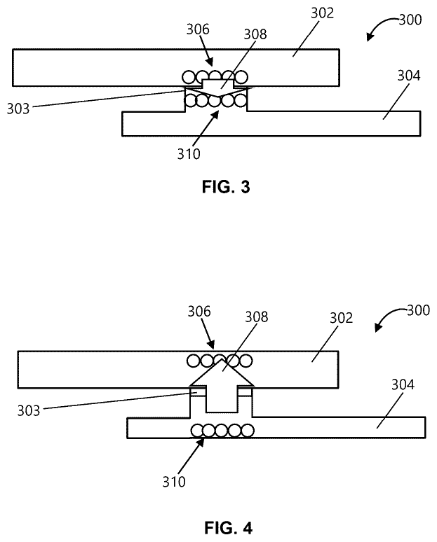

FIG. 3 illustrates a schematic diagram of the III-V/Si hybrid MOS optical modulator 300 consistent with the modulator of FIG. 1 operated under the forward bias. The n-III-V material 302, p-Si material 304 and oxide layer 303 are shown in FIG. 3 and FIG. 4. FIG. 3 shows the modulator under the forward bias (with electric field E 308). 306 and 310 are the electrons and holes in the n-III-V material and p-Si material respectively. The III-V/Si hybrid MOS optical modulator under the forward bias demonstrated high modulation efficiency (V_{π}L<0.1 Vcm depending on the oxide thickness) owning to the efficient free-carrier dispersion effect in III-V material.

As shown in FIG. 4, the modulator 300 is driven under a reverse bias. It should be noted that the present invention can operate under forward bias by utilizing carrier accumulation as well as reverse bias (with electric field E 308) by utilizing carrier depletion and F-K effect for optical modulation. The present invention provides a design of a traveling wave electrode with SPP driving scheme to mitigate the influence of large capacitance for high-speed modulation. It should be noted that FIGS. 3 and 4 explain the modulation mechanism by free-carriers and does not relate directly to the traveling-wave electrode design.

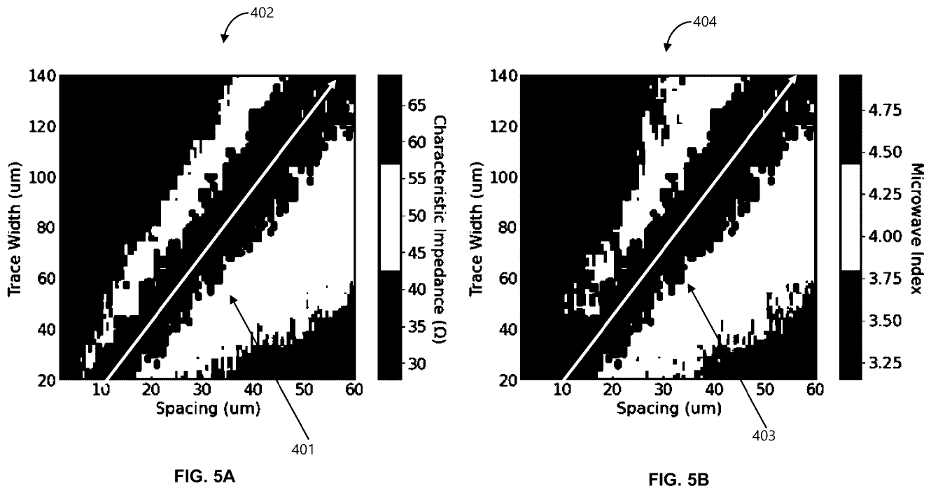

FIG. 5A illustrates a characteristic impedance graph 402 of the III-V/Si hybrid MOS optical modulator under the forward biasing drawn taking electrode spacing along X-axis and electrode trace width along Y-axis during the carrier accommodation. FIG. 5A shows the results from the simulation on a III-V/Si hybrid MOS optical modulator with Si waveguide width=500 nm and oxide layer thickness tₒₓ=45 nm. FIG. 5B illustrates a microwave index graph 404 of the III-V/Si hybrid MOS optical modulator under the forward bias drawn taking electrode spacing along X-axis and electrode trace width along Y-axis during carrier accommodation in forward bias. The relationship between electrode spacing(S) and width (W) that enables impedance and velocity matching is that W=2.667*S−6.67. The area 401 and 403 represents the position where impedance and velocity matching are achieved simultaneously.

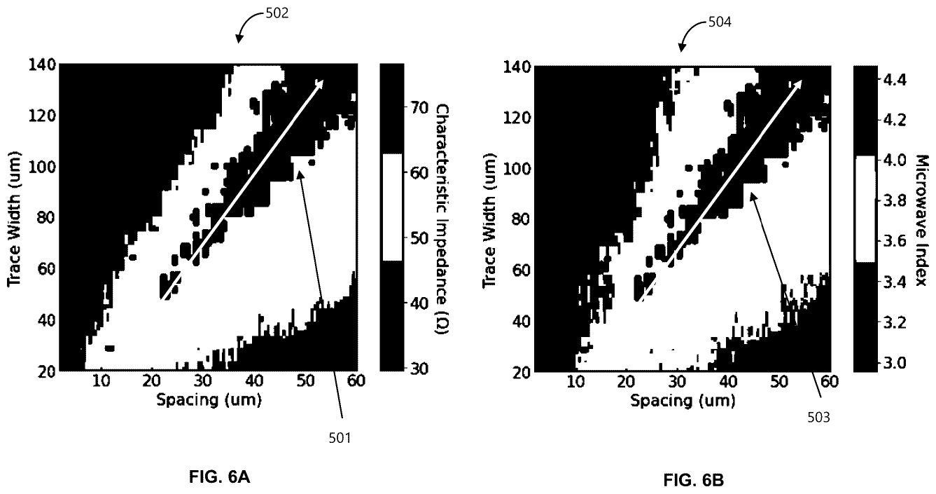

FIG. 6A illustrates a characteristic impedance graph 502 of the III-V/Si hybrid MOS optical modulator under the reverse bias drawn taking electrode spacing along X-axis and electrode trace width along Y-axis during carrier depletion. FIG. 6A shows the results from simulation on a III-V/Si hybrid MOS optical modulator with Si waveguide width=500 nm and oxide layer thickness tₒₓ=10 nm. FIG. 6B illustrates a microwave index graph 504 of the III-V/Si hybrid MOS optical modulator under the reverse bias drawn taking electrode spacing along X-axis and electrode trace width along Y-axis during carrier depletion. The relationship between electrode spacing(S) and width (W) that enables impedance and velocity matching is that W=3.08*S−34.47. The area 501 and 503 represents the position where impedance and velocity matching are achieved simultaneously.

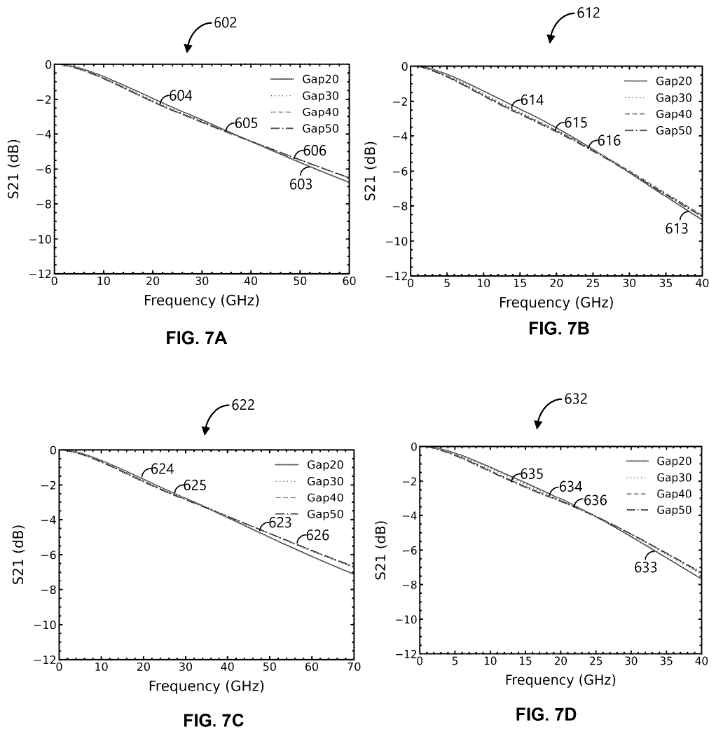

FIG. 7A illustrates a simulated modulation bandwidth graph 602 drawn taking frequency along X-axis and S-21 response along Y-axis during carrier accommodation in forward bias with an oxide layer thickness of 45 nm and V_{π}L=0.6 Vcm. The graph indicates that the 3-dB modulation bandwidth is 57 GHz with phase shifter length=0.5 mm, V_{π}=12 V and Vₚₚ=4.8 V. V_{π} is the voltage required for π phase shift and Vₚₚ is the voltage swing of modulating signal. The graphs 603, 604, 605 and 606 are drawn at Gap20, Gap30, Gap40 and Gap50. Gap20, Gap30, Gap40 and Gap50 correspond to the electrode spacing of 20 μm, 30 μm, 40 μm and 50 μm, respectively.

FIG. 7B illustrates another simulated modulation bandwidth graph 612 drawn taking frequency along X-axis and S-21 response along Y-axis during carrier accommodation in forward bias with an oxide layer thickness of 45 nm and V_{π}L=0.6 Vcm. The graph indicates that the 3-dB modulation bandwidth is 31 GHz with phase shifter length=1 mm, V_{π}=6 V and Vₚₚ=2.4 V. The graphs 613, 614, 615 and 616 are drawn at Gap20, Gap30, Gap40 and Gap50.

FIG. 7C illustrates a simulated modulation bandwidth graph 622 drawn taking frequency along X-axis and S-21 response along Y-axis during carrier depletion in reverse bias with an oxide layer thickness of 10 nm and V_{π}L=0.15 Vcm. The graph indicates that the 3-dB modulation bandwidth is 63 GHz with phase shifter length=0.5 mm, V_{π}=3 V and Vₚₚ=1.2 V. The graphs 623, 624, 625 and 606 are drawn at Gap20, Gap30, Gap40 and Gap50.

FIG. 7D illustrates another simulated modulation bandwidth graph 632 drawn taking frequency along X-axis and S-21 response along Y-axis during depletion in reverse bias with an oxide layer thickness of 45 nm and V_{π}L=0.6 Vcm. The graph indicates that the 3-dB modulation bandwidth is 35 GHz with phase shifter length=1 mm, V_{π}=1.5 V and Vₚₚ=0.6 V. The graphs 633, 634, 635 and 636 are drawn at Gap20, Gap30, Gap40 and Gap50.

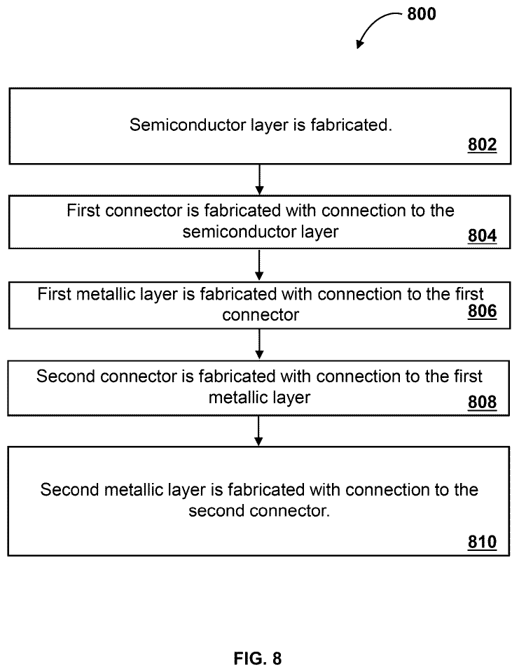

FIG. 8 illustrates a flow chart of an example process 800 of achieving the structure for manufacturing of a traveling-wave electrode used in a III-V/Si hybrid MOS optical modulator. As at step 802, the semiconductor layer is firstly fabricated. In this step, the oxide layer thickness between III-V and Si layer is controlled to get the designed capacitance. As at step 804, the first connector is fabricated with connection to the semiconductor layer. Then, as at step 806, the first metallic layer is fabricated with connection to the first connector. Then, the second connector is fabricated with connection to the first metallic layer, as at step 808. The second metallic layer is fabricated with connection to the second connector, as at step 810. The width of second metallic sections in the second layer and the spacing between adjacent second metallic sections in the second layers are determined by the simulation. The series-push-pull (SPP) driving scheme halves the large oxide capacitance which makes the impedance and velocity matching possible.

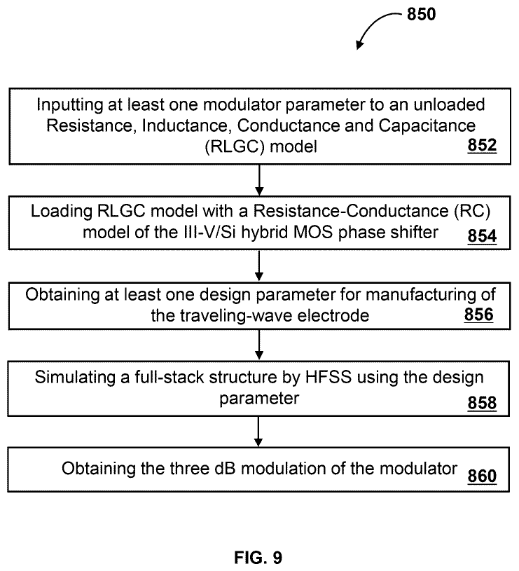

FIG. 9 illustrates a flow chart of an example process 850 of obtaining the electrode design to achieve the impedance and velocity matching of the traveling-wave modulator. As at step 852, at least one electrode design is inputted to an unloaded Resistance, Inductance, Conductance and Capacitance (RLGC) model. Then, as at step 854, the RLGC model is loaded with a Resistance-Capacitance (RC) model of the III-V/Si hybrid MOS phase shifter. Then, as at step 856, at least one design parameter for manufacturing of the traveling-wave electrode is obtained. A full-stack structure is simulated with High Frequency Structure Simulator using the design parameter, as at step 858. As at step 860, the 3-dB modulation bandwidth of the modulator is obtained.

III-V/Si hybrid Metal-Oxide-Semiconductor (MOS) optical modulator is promising for high-efficiency, low-energy and high-speed optical modulation. However, no traveling-wave electrode has been demonstrated on this kind of modulator due to the large oxide capacitance which makes the impedance and velocity matching challenging. In the present invention, a design of traveling-wave electrode for III-V/Si hybrid MOS optical modulator is disclosed. By using series-push-pull (SPP) configuration and different biasing schemes, the impedance and velocity matching is achieved, leading to an over-60 GHz modulation bandwidth with a small bias voltage.

The high modulation efficiency of III-V/Si hybrid MOS optical modulator enables a short optical phase shifter length with a low driving voltage. The short phase shifter length leads to a reduced RF loss and enhanced modulation bandwidth. The SPP driving scheme reduces the device capacitance by half, making the impedance and velocity matching possible.

In particular, traveling-wave electrodes were designed to integrate with III-V/Si hybrid MOS optical modulator under forward (carrier-accumulation) and reverse (carrier-depletion) bias. The following Table 1 shows the various parameters of traveling-wave electrodes under forward and reverse bias conditions. Referring to the Table 1 below, EOT is the oxide layer thickness, L is the phase shifter length, V_{π} is the voltage required for π phase shifter, V_{π}L is the product of the V_{π} and the L, Vₚₚ is the driving peak-to-peak voltage, and f_{3 dB} is the 3-dB modulation bandwidth. By adjusting the electrode trace width and the metal electrode spacing to a predetermined value, along with other parameters and biasing scheme, a structure is achieved to obtain the matching of impedance and velocity for the traveling-wave modulator.

TABLE 1

| | EOT | L | V_{π} | V_{π}L | Vₚₚ | f_{3dB} |
|---|---|---|---|---|---|---|
| | (nm) | (mm) | (V) | (Vcm) | (V) | (GHz) |
| Forward | 45 | 0.5 | 12.0 | 0.6 | 4.8 | 57 |
| bias | | 1.0 | 6.0 | 0.6 | 2.4 | 31 |
| Reverse | 10 | 0.5 | 3.0 | 0.15 | 1.2 | 63 |
| bias | | 1.0 | 1.5 | 0.15 | 0.6 | 35 |

The present invention describes about the design of traveling-wave electrodes on III-V/Si hybrid MOS optical modulators. The techniques proposed are also applicable to other optical modulators based on a metal-oxide-semiconductor (MOS) or semiconductor-insulator-semiconductor (SIS) capacitor, such as SiGe/Si or poly-Si/Si. The III-V material of present invention can be not limited to InGaAsP, InP or other III-V compound material with strong optical-electrical effect. The traveling-wave electrode designed for III-V/Si hybrid MOS optical modulator enables a larger modulation bandwidth, overcoming the RC limitation posed by the lumped electrode. With a short phase shifter of 500 mm, a bandwidth over 60 GHz is predicted.

It will be appreciated that variations of the above disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

Although embodiments of the current disclosure have been described comprehensively in considerable detail to cover the possible aspects, those skilled in the art would recognize that other versions of the disclosure are also possible.

1. A III-V/Si hybrid MOS optical modulator with a traveling-wave electrode comprising:
a first and second metallic layer serving as the traveling-wave electrode;
a III-V compound semiconductor layer and a silicon layer;
an oxide layer between the III-V compound semiconductor layer and the silicon layer,
wherein the oxide layer thickness is designed to allow for the impedance and velocity matching of the modulator.

2. The modulator of claim 1, further comprising at least one first connector and at least one second connector.

3. The modulator of claim 1, wherein the traveling-wave electrode is driven by a Series-Push-Pull (SPP) driving scheme.

4. The modulator of claim 1, wherein the first metallic layer comprises three first metallic sections separate from each other.

5. The modulator of claim 1, wherein the second metallic layer comprises two second metallic sections separate from each other.

6. The modulator of claim 5, wherein each second metallic section has a spacing distance between adjacent second metallic sections of about 5 μm to 60 μm.

7. The modulator of claim 1, wherein the thickness of the oxide layer is from about 5 nm to 50 nm.

8. The modulator of claim 1, wherein the III-V compound semiconductor layer comprises InGaAsP, InP or other III-V compound material with strong optical-electrical effect.

9. A method for manufacturing of a III-V/Si hybrid MOS optical modulator with a traveling-wave electrode, comprising steps of:
fabricating a III-V compound semiconductor layer and a silicon layer, wherein an oxide layer is between the III-V compound semiconductor layer and the silicon layer;
fabricating at least one first connector with connection to the III-V compound semiconductor layer;
fabricating a metallic section of a first metallic layer with connection to the at least one first connector, wherein the first metallic layer comprises multiple metallic sections;
fabricating at least one second connector with connection to another metallic section from the multiple metallic sections of the first metallic layer; and
fabricating a second metallic layer with connection to the at least one second connector,
wherein the oxide layer thickness is designed to allow for the impedance and velocity matching of the modulator.

10. The method of claim 9, wherein the traveling-wave electrode is driven by a Series-Push-Pull (SPP) driving scheme.

11. The method of claim 9, wherein the first metallic layer comprises three first metallic sections separate from each other.

12. The method of claim 9, wherein the second metallic layer comprises two second metallic sections separate from each other.

13. The method of claim 12, wherein each second metallic section has a spacing distance between adjacent second metallic sections of about 5 μm to 60 μm.

14. The method of claim 9, wherein the thickness of the oxide layer is from about 5 nm to 50 nm.
